(19) United States
(12) Patent Application Publication
(10) Pub. No.: US 2012/0096286 A1
(43) Pub. Date: Apr. 19, 2012

(54) CHARGING MANAGEMENT METHOD, CHARGING CONTROL CIRCUIT AND THE HOST APPARATUS HAVING THE SAME

(75) Inventors: Pai-Ching Huang, Taipei City (TW); Che-Wei Lin, Taipei City (TW); Hung-Hsiang Chen, Taipei City (TW); Chang-Yu Hsieh, Taipei City (TW); Li-Chien Wu, Taipei City (TW)

(73) Assignee: ASUSTEK COMPUTER INC., Taipei City (TW)

(21) Appl. No.: 13/241,231

(22) Filed: Sep. 23, 2011

(30) Foreign Application Priority Data
Oct. 14, 2010 (TW) 99135065

(51) Int. Cl. G06F 1/26

(52) U.S. Cl. 713/300

(57) ABSTRACT

A control circuit of universal serial bus (USB) port includes a charge control unit providing a first operating voltage and a second operating voltage to a first operating voltage end and a second operating voltage end of the USB port, and a first circuit unit coupled to the charge control unit. Furthermore, the first circuit includes a first output end and a second output end. When a external apparatus is inserted into the USB port, the charge control unit connects the first output end and the second output end to a differential positive end and a differential negative end of the USB port, respectively, to enter a rapid charging mode.

### CROSS-REFERENCE TO RELATED APPLICATION

This application claims the priority benefit of Taiwan application serial no. 99135065, filed on Oct. 14, 2010. The entirety of the above-mentioned patent application is hereby incorporated by reference herein and made a part of this specification.

### BACKGROUND OF THE INVENTION

1. Field of the Invention

The invention relates to a host apparatus, a management method and a control circuit and, more particularly, to a charging management method and a charging control circuit via a USB port in a host apparatus.

2. Description of the Related Art

In general, to comply with the USB standard, the USB port at least includes four ends, that is, a first operating voltage end, a differential positive end, a differential negative end and a second operating voltage end. The first operating voltage end is a +5V voltage end, the second operating voltage end is a ground end, and the differential positive end and the differential negative end are for data transfer.

Due to widely use of the USB, many portable apparatuses (such as a mobile phone, a pocket PC, a digital camera or a digital media device) utilize a USB port to transfer data with the USB port on the host apparatus. Additionally, the external apparatus can also be charged via the +5V voltage end and the ground end of the USB port on the host apparatus.

Manufacturers of the external apparatus usually provide an adapter to generate a +5V voltage and a ground voltage. The external apparatus is charged via a USB transmission cable connected to the USB port of the external apparatus and the adapter.

Since the current provided by the adapter and the host apparatus are different, the external apparatus need to distinguish whether the power provided by the USB port is from the host apparatus or the adapter. When the external apparatus confirms that the power of the USB port is from the adapter, the external apparatus enters a rapid charging mode and receives a more than 0.5 A charging current from the adapter. On the contrary, when the external apparatus confirms that the power of the USB port is from the host apparatus, the external apparatus enters a normal charging mode and receives a 0.5 A charging current at most from the USB port of the host apparatus.

The external apparatus usually determines whether the power of the USB port is from the host apparatus or the adapter according to signal relation between the differential positive end and the differential negative end. For example, if the USB port of the adapter makes the differential positive end and the differential negative end short-circuited, the external apparatus can determine that the power of the USB port is from the adapter accordingly.

Except for making the differential positive end and the differential negative end short-circuited, other connection modes between the differential positive end and the differential negative end of the USB port of the adapter can also make the external apparatus determine the power source accordingly.

FIG. 1A is a schematic diagram showing a conventional rapid charging architecture. In FIG. 1A, when a external apparatus 102 is connected to an adapter 106 via a USB transmission cable 104, and the adapter 106 is connected to alternating current (AC), the external apparatus 102 enters a rapid charging mode according to the short circuit between a differential positive end D+ and a differential negative end D− in the adapter 106. At the moment, the external apparatus 102 receives a charging current Ich1 about 1.5 A from the adapter 106 for rapid charging.

FIG. 1B is a schematic diagram showing a conventional normal charging architecture. In FIG. 1B, the external apparatus 102 is also connected to a USB port 114 of a host apparatus 112 via a USB transmission cable 104 for charging. Since the USB signal is provided by the USB control unit 116 of the host apparatus 112, and the differential positive end D+ and the differential negative end D− are not short-circuited, the external apparatus 102 determines that the power of the USB port is from the USB control unit 116 of the host apparatus 112. According to USB 2.0 standard, the USB control unit 116 can provide a charging current Ich2 of 0.5 A at most to the external apparatus 102. Consequently, when the host apparatus 112 detects that the portable apparatus 102 is connected to the USB port 114 with USB transmission cable 104, a normal charging mode is executed, and the external apparatus 102 is charged by the charging current Ich2 of 0.5 A from the USB control unit 116. The charging time of the normal charging mode is longer than that of the rapid charging mode.

The USB standard has already developed to USB 3.0. In the USB 3.0 standard, the USB 3.0 port is compatible with the USB 2.0 port, and a control unit of the USB 3.0 can provide a current of 1.5 A. However, when the external apparatus 102 detects that the USB transmission cable 104 is connected to the USB 2.0 port or the USB 3.0 port of the host apparatus, it only enters the normal charging mode to provide a current of 1.5 A, but does not enter the rapid charging mode. Thus, the charging efficiency is low. Moreover, the manufacturers of the external apparatus can design kinds of connection types between the differential positive end and the differential negative end of the USB port of the adapter, and thus the external apparatus sometimes cannot determine whether to enter the rapid charging mode or not.

### BRIEF SUMMARY OF THE INVENTION

A host apparatus which allows a external apparatus to enter a rapid charging mode via a USB port of the host apparatus is provided. The host apparatus includes a motherboard, a daughter board and a charging management module. The motherboard includes a first connector. The daughter board is coupled to the first connector and includes a rapid charging port. The rapid charging port includes a first signal end and a second signal end. The charging management module is disposed on the daughter board. When a external apparatus is inserted into the rapid charging port, the charging management module sets the first signal end and the second signal end as a first state connection, and if the external apparatus does not give a response to the charging management module in the first state connection, the charging management module switches the first signal end and the second signal end to a second state connection to enter a rapid charging mode, respectively.

A management method of the USB port is also provided. The USB port at least includes a first operating voltage end, a second operating voltage end, a differential positive end and a differential negative end. The management method includes the following steps: applying a first operating voltage and a second operating voltage to the first operating voltage end and the second operating voltage end, respectively, and setting the differential positive end and the differential negative end as a first state connection when a external apparatus is inserted into the USB port; determining whether a response from the external apparatus is received; setting the differential positive end and the differential negative end as a second state connection when no response from the external apparatus is received.

A control circuit of the USB port is further provided. The control circuit includes a charge control unit and a first circuit unit. The charge control unit provides a first operating voltage and a second operating voltage to a first operating voltage end and a second operating voltage end of the USB port. The first circuit unit is coupled to the charge control unit, and includes a first output end and a second output end. When the external apparatus is inserted into the USB port, the charge control unit connects the first output end and the second output end to a differential positive end and a differential negative end of the USB port, respectively, to enter a rapid charging mode.

Since when the external apparatus is inserted into the USB port of the host apparatus, the state of the differential positive end and the differential negative end of the USB port can be set in an embodiment. Consequently, the external apparatus can enter a rapid charging mode, and the charging efficiency is improved.

These and other features, aspects and advantages of the present invention will become better understood with regard to the following description, appended claims, and accompanying drawings.

### BRIEF DESCRIPTION OF THE DRAWINGS

FIG. 1A is a schematic diagram showing a conventional rapid charging architecture;

FIG. 1B is a schematic diagram showing a conventional normal charging architecture;

FIG. 2A and FIG. 2B are schematic diagrams showing architectures of USB ports of different adapters;

FIG. 2C is a schematic diagram showing connection between a USB transmission cable and a portable apparatus;

FIG. 3 is a block diagram showing a system of a host apparatus in an embodiment;

FIG. 4 is a schematic diagram showing a daughter board in an embodiment;

FIG. 5 is a block diagram showing a charging management module in an embodiment; and

FIG. 6 is a flow chart showing a management method of a USB port in an embodiment.

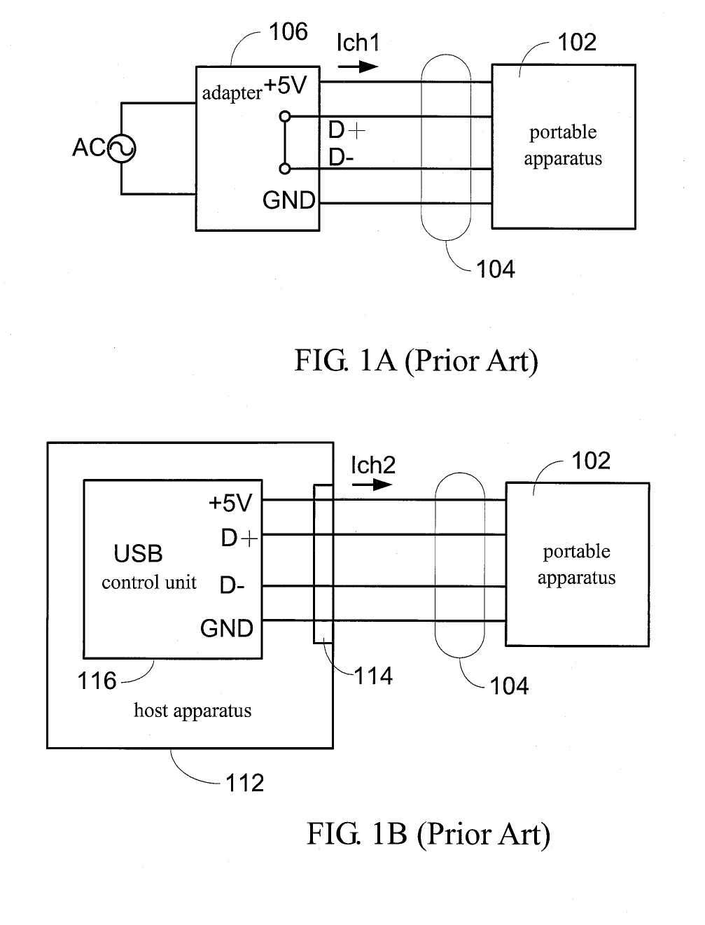

### DETAILED DESCRIPTION OF THE EMBODIMENTS

Different connection types between the differential positive end and the differential negative end of the USB port of the adapter can be designed, and the external apparatus can determine whether to enter a rapid charging mode. Two typical connection types between the differential positive end and the differential negative end of the adapter are taken as examples for illustrating hereinafter.

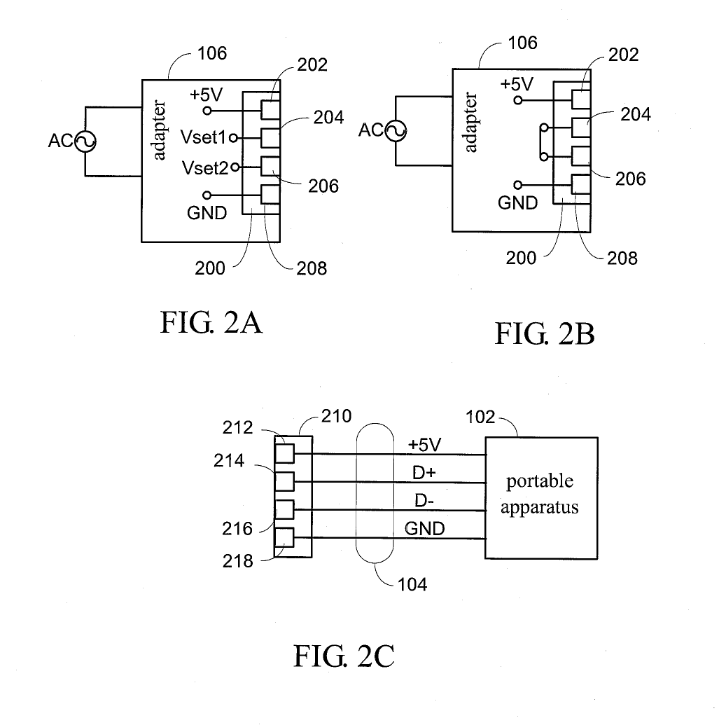

FIG. 2A and FIG. 2B are schematic diagrams showing architectures of the USB ports of two kinds of adapters. In FIG. 2A, a USB port 200 (or called a USB female port) of the adapter 106 includes a first operating voltage end 202, a differential positive end 204, a differential negative end 206 and a second operating voltage end 208. The first operating voltage end 202 receives a first operating voltage such as +5V, and the second operating voltage end 208 receives a second operating voltage, such as a ground voltage (GND). That is, when the adapter 106 is coupled to the alternating current (AC), the voltage at the first operating voltage end 202 is +5V, and the voltage at the second operating voltage end 208 is ground (GND) voltage.

In FIG. 2A, different setting voltages are applied at the differential positive end D+ 204 and the differential negative end D− 206 of the USB port 200 of the adapter 106 (the first setting voltage Vset1 and the second setting voltage Vset2), respectively. In FIG. 2B, the differential positive end D+ 204 and the differential negative end D− 206 of the USB port 200 of the adapter 106 are short-circuited via a circuit in the adapter 106.

As shown in FIG. 2C, a plug 210 (or called a USB male port) of the USB transmission cable 104 also includes a first operating voltage end 212 (+5V), a differential positive end D+ 214, a differential negative end D− 216 and a second operating voltage end 218 (GND). When the plug 210 is inserted into the USB port 200 shown in FIG. 2A or FIG. 2B, the first operating voltage end 212, the differential positive end 214, the differential negative end 216 and the second operating voltage end 218 are respectively connected to the first operating voltage end 202, the differential positive end 204, the differential negative end 206 and the second operating voltage end 208 of the USB port 200 of the adapter 106 correspondingly. Thus, when the external apparatus 102 detects that the voltage at the differential positive end D+ 214 and the differential negative end D− 216 are the preset voltages (Vset1 and Vset2) or detects a short circuit between the differential positive end 214 and the differential negative end 216, it is determined that the plug 210 is connected to the adapter 106, and the rapid charging mode is executed.

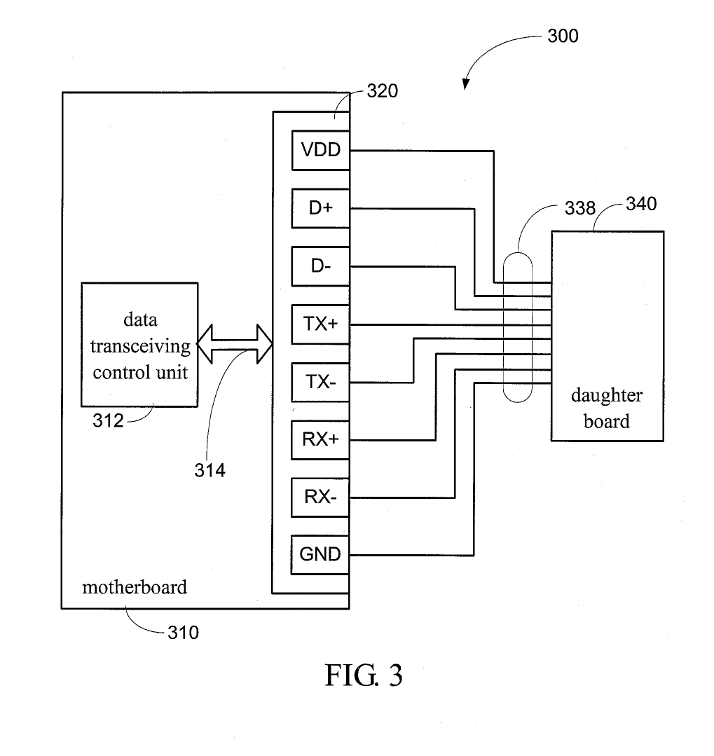

The external apparatus can enter the rapid charging mode after the determination, and accordingly, a corresponding structure is disposed on the host apparatus to allow the host apparatus to switch from a normal charging mode to a rapid charging mode. FIG. 3 is a block diagram showing a system of a host apparatus in an embodiment. In FIG. 3, the host apparatus 300 in the embodiment includes a motherboard 310 and a daughter board 340. The host apparatus 300 may be a computer host, a control circuit is disposed on the daughter board 340, and the daughter board 340 may be disposed on front panel of a casing of the computer host.

The motherboard 310 includes a data transceiving control unit 312 which can receive and transfer data via a data transmission protocol. In the embodiment, the data transceiving control unit 312 is a control chip of USB 3.0 standard, and it can receive and transfer data via the USB 3.0 transmission protocol.

A first connector 320 is disposed on the motherboard 310. The first connector 320 includes a first operating voltage end VDD, a differential positive end D+, a differential negative end D−, a transmission positive end TX+, a transmission negative end TX−, the receiving positive end RX+, a receiving negative end RX− and a second operating voltage end GND. Layout traces 314 on the motherboard 310 are used to connect the data transceiving control unit 312 to the first connector 320 correspondingly. Furthermore, the first operating voltage end VDD and the second operating voltage end GND output a voltage of +5V and a ground voltage, respectively. A connecting cable 338 of the host apparatus 300 connects all the USB 3.0 signal ends of the first connector 320 to the daughter board 340. In the embodiment, the connecting cable 338 may be a coaxial cable which may be one to three meters in length.

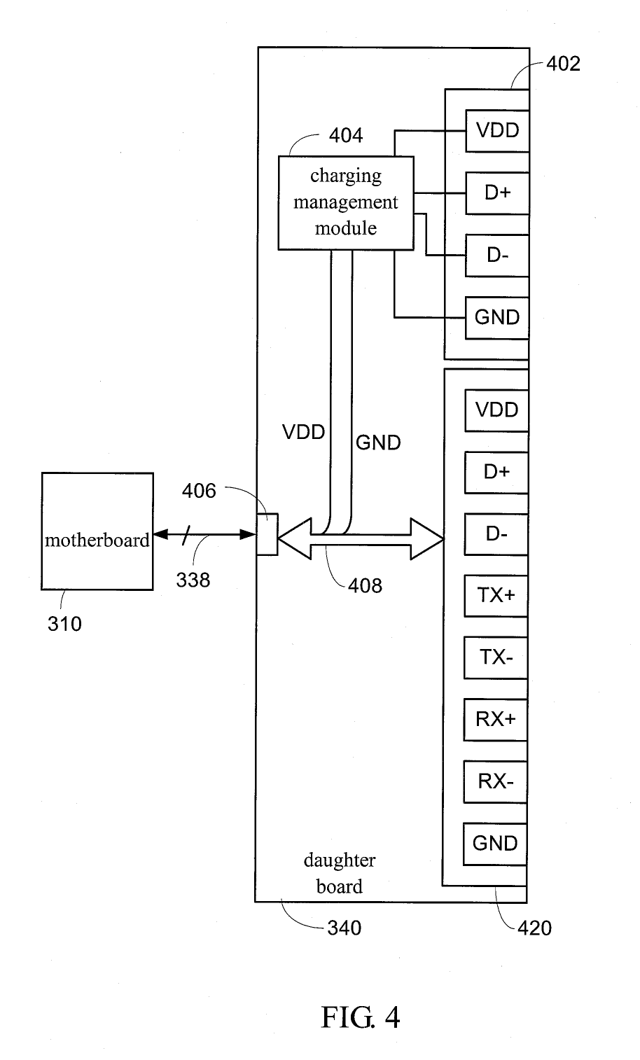

FIG. 4 is a schematic diagram showing a daughter board in an embodiment. The motherboard 310 transmits all of the signals of the USB 3.0 standard to a second connector 406 of the daughter board 340 via the connecting cable 338. The connections are already shown in FIG. 3, which is omitted herein.

The daughter board 340 includes a rapid charging port 402, a USB 3.0 input/output (I/O) port 420 and a charging management module 404 thereon. The layout traces 408 on the daughter board 340 are used to connect the USB 3.0 I/O port 420 and the second connector 406. That is, the signals of the USB 3.0 are transmitted to the USB 3.0 I/O port 420. Thus, the USB module at least includes the layout traces 408 and the USB 3.0 I/O port 420.

According to the embodiment, the charging management module 404 is connected to the first operating voltage end VDD and the second operating voltage end GND of the USB 3.0 signal, and connected to the first operating voltage end VDD, the differential positive end D+, the differential negative end D− and the second operating voltage end GND of the rapid charging port 402. The rapid charging port 402 is a USB female port. Furthermore, the rapid charging port 402 and the USB 3.0 I/O port 420 are disposed at the front panel of the casing of the host apparatus 300 in the embodiment.

Consequently, as shown in FIG. 2C, the external apparatus 102, such as a mobile phone, a pocket PC, a digital camera or a digital media device, can use the USB transmission cable 104 to insert to the rapid charging port 402 in FIG. 4 via the USB plug 210. Since the USB 3.0 port is compatible with the USB 2.0 port, the USB plug 210 of the external apparatus 102 in the embodiment may be a USB 2.0 plug or a USB 3.0 plug.

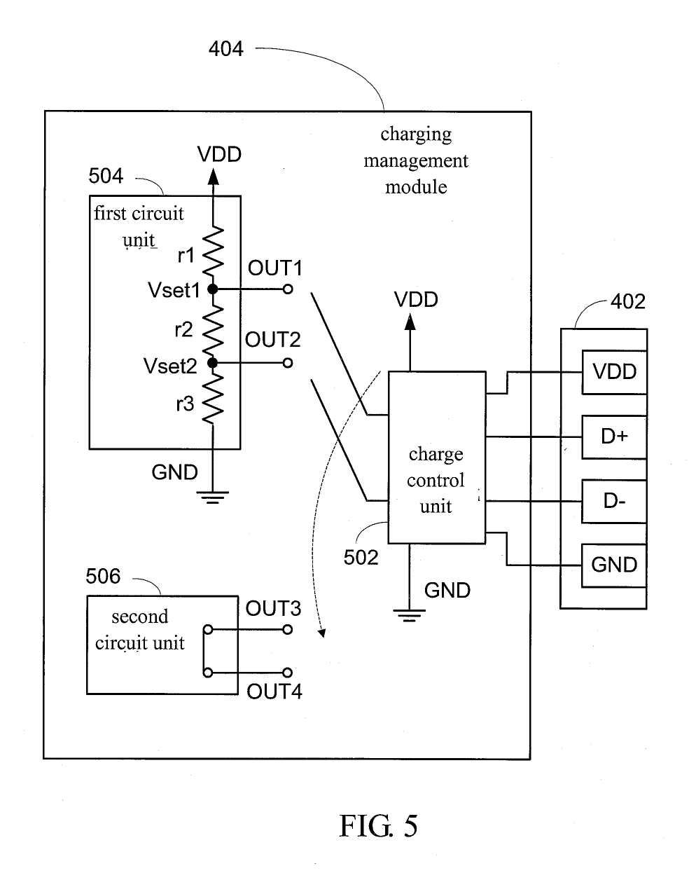

FIG. 5 is a block diagram showing a charging management module in an embodiment. In FIG. 5, the charging management module 404 in the embodiment at least includes a charge control unit 502, a first circuit unit 504 and a second circuit unit 506. The charge control unit 502 can couple the first output end OUT1 and the second output end OUT2 of the first circuit unit 504 to the differential positive end D+ and the differential negative end D− of the rapid charging port 402, or couple the third output end OUT3 and the fourth output end OUT4 of the second circuit unit 506 to the differential positive end D+ and the differential negative end D− of the rapid charging port 402. The charge control unit 502 can also connect the first operating voltage VDD and the second operating voltage GND to the first operating voltage end VDD and the first operating voltage end GND of the rapid charging port 402.

As shown in FIG. 5, the first circuit unit 504 includes three resistors r1, r2 and r3 connected in series between the first operating voltage VDD and the second operating voltage GND. The first output end OUT1 and the second output end OUT2 output the first setting voltage Vset1 and the second setting voltage Vset2. For example, Vset1 is 2.0V, and Vset2 is 1.8V. Moreover, the third output end OUT3 and the fourth output end OUT4 of the second circuit unit 506 are short-circuited.

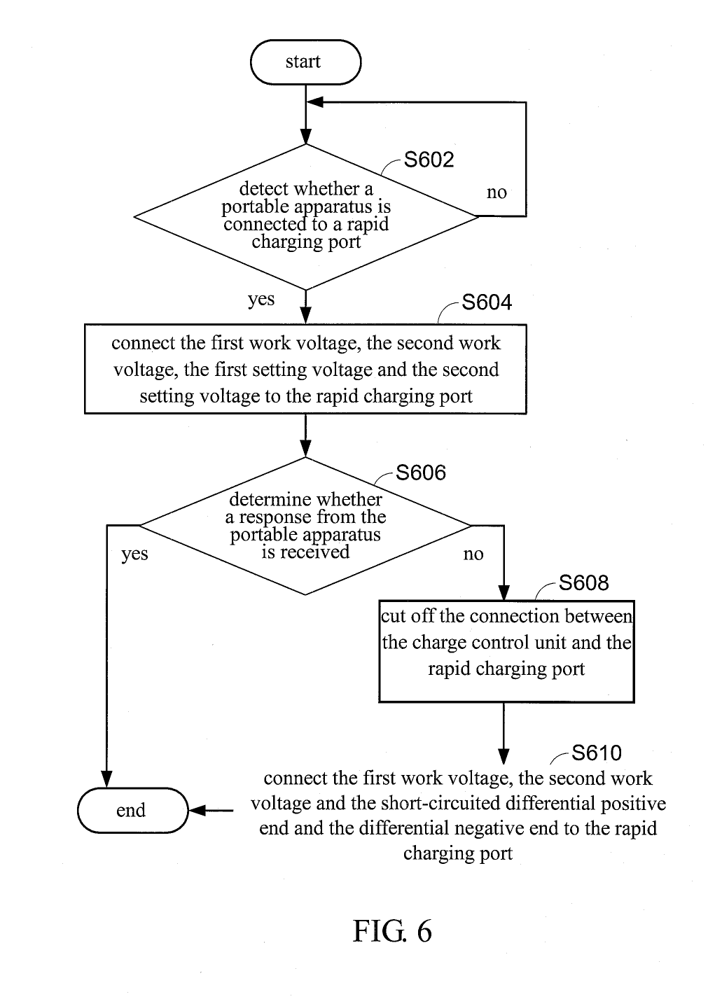

FIG. 6 is a flow chart showing a management method of the USB port in an embodiment. Please refer to FIG. 2C, FIG. 4, FIG. 5 and FIG. 6, the charge control unit 502 detects whether a external apparatus is connected to the rapid charging port 402 continuously as in Step S602. When the charge control unit 502 does not detect that a external apparatus 102 is connected to the USB port 420 via the USB plug 210, the Step S602 is executed repeatedly. On the contrary, when the charge control unit 502 detects a external apparatus 102 is connected to the USB port 420 via the USB plug 210, Step S604 is executed, that is, the charge control unit 502 applies the first operating voltage VDD, the second operating voltage GND, the first setting voltage Vset1 and the second setting voltage Vset2 to the first operating voltage end VDD, the second operating voltage end GND, the differential positive end D+ and the differential negative end D− of the rapid charging port 402 correspondingly. In other words, the charge control unit 502 is switched to be connected to the first output end OUT1 and the second output end OUT2 of the first circuit unit 504.

Then, in Step S606, the charge control unit 502 determines whether a response from the external apparatus 102 is received. If true, it means that the host apparatus is capable of executing the rapid charging mode as shown in FIG. 2A, and when the external apparatus regards the rapid charging port 402 as the USB port of the adapter according to the first setting voltage Vset1 and the second setting voltage Vset2 of the differential positive end D+ and the differential negative end D− of the rapid charging port 402, the external apparatus 102 gives a response to the charge control unit 502. When the charge control unit 502 receives the response from the external apparatus 102, it means that the external apparatus already recognizes the USB port as the USB port of the adapter, and the rapid charging mode is executed.

The charge control unit 502 may also determines whether the external apparatus 102 gives a response according to the charging current. For example, when the charge control unit 502 confirms that the charging current is about 0.5 A, it is determined that the external apparatus 102 gives no response. On the contrary, when the charge control unit 502 confirms that the charging current is more than 0.5 A or even about 1.5 A, it is determined that the external apparatus 102 gives a response.

If the charge control unit 502 does not receive the response from the external apparatus 102, Step S608 is executed, that is, the connection between the charge control unit 502 and the rapid charging port 402 is cut off. Then, the charge control unit 502 is switched to be connected to the third output end OUT3 and the fourth output end OUT4 of the second circuit unit 506 and applies the first operating voltage VDD and the second operating voltage GND to the first operating voltage end VDD and the second operating voltage end GND of the rapid charging port 402 correspondingly. The differential positive end D+ and the differential negative end D− are short-circuited, which meets to the rapid charging mode in FIG. 2B.

When the external apparatus regards the rapid charging port 402 as the USB port of the adapter according to the short-circuited differential positive end D+ and the differential negative end D− of the rapid charging port 402, it means that the external apparatus already regards the USB port as the USB port of the adapter, the rapid charging mode can be executed.

As stated above, the charge control unit 502 includes two state connections, in a preset state connection (the first state connection), the first setting voltage Vset1 and the second setting voltage Vset2 are provided to the differential positive end D+ and the differential negative end D−. When the charging control unit 502 cannot receive a response from the external apparatus in the preset state connection, the preset state connection is switched to another state connection (the second state connection) which can provide the short-circuited differential positive end D+ and the differential negative end D−.

The two state connections can be exchanged, which means the differential positive end D+ and the differential negative end D− are short-circuited in the preset state connection (the first state connection), and the first setting voltage Vset1 and the second setting voltage Vset2 are provided to the differential positive end D+ and the differential negative end D− in another state connection (the second state connection). Moreover, it is not limited to the two state connections herein, three or more different combinations of state connections, as long as it can switch and provide the rapid charging mode according to the connection type of the differential positive end and the differential negative end of the USB port of the adapter, are all within the scope.

In sum, since a rapid charging port in the embodiment can stimulate the state of the USB port of the adapter, the external apparatus is allowed to enter a rapid charging mode via the host apparatus, so as to improve the charging efficiency of the portable apparatus.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A host apparatus comprising:
a motherboard including a first connector;
a daughter board coupled to the first connector and including a rapid charging port, wherein the rapid charging port includes a first signal end and a second signal end; and
a charging management module disposed on the daughter board, wherein when a external apparatus is inserted into the rapid charging port, the charging management module sets the first signal end and the second signal end as a first state connection, and if the external apparatus does not a response to the charging management module in the first state connection, the charging management module switches the first signal end and the second signal end, respectively, to a second state connection to enter a rapid charging mode.

2. The host apparatus according to claim 1, wherein the charging management module comprises:
a first circuit unit including a first output end and a second output end outputting a first setting voltage and a second setting voltage, respectively;
a second circuit unit including a third output end and a fourth output end, wherein the third output end and the fourth output end are short-circuited; and
a charge control unit, wherein when in the first state connection, the charge control unit couples the first output end and the second output end to the first signal end and the second signal end, respectively, and when in the second state connection, the charge control unit switches the first signal end and the second signal end to couple to the third output end and the fourth output end, respectively.

3. The host apparatus according to claim 1, wherein if the external apparatus responses to the charging management module in the first state connection, the rapid charging mode is executed directly.

4. The host apparatus according to claim 1, wherein the rapid charging port further includes a first operating voltage end and a second operating voltage end, and when the rapid charging mode is executed, the first operating voltage end and the second operating voltage end provide a first operating voltage and a second operating voltage, respectively, to charge the external apparatus.

5. The host apparatus according to claim 4, wherein the rapid charging port is a universal serial bus (USB) port.

6. The host apparatus according to claim 1, wherein the daughter board further includes a USB port module signally connected to the first connector.

7. The host apparatus according to claim 1, wherein the daughter board is coupled to the first connector via a USB interface.

8. A management method of a the USB port, wherein the USB port at least includes a first operating voltage end, a second operating voltage end, a differential positive end and a differential negative end, the management method comprising following steps:
applying a first operating voltage and a second operating voltage to the first operating voltage end and the second operating voltage end, respectively, and setting the differential positive end and the differential negative end as a first state connection when a external apparatus is inserted into the USB port;
determining whether a response from the external apparatus is received; and
setting the differential positive end and the differential negative end as a second state connection when no response from the external apparatus is received.

9. The management method according to claim 8, wherein the step of setting the differential positive end and the differential negative end as the first state connection includes applying a first setting voltage and a second setting voltage to the differential positive end and the differential negative end, respectively.

10. The management method according to claim 8, wherein when the differential positive end and the differential negative end are in the first state connection and no response from the external apparatus is received, in the second state connection, the differential positive end and the differential negative end are short-circuited.

11. A control circuit of a USB port comprising:
a charge control unit providing a first operating voltage and a second operating voltage to a first operating voltage end and a second operating voltage end of the USB port; and
a first circuit unit coupled to the charge control unit and including a first output end and a second output end;
wherein when an external apparatus is coupled to the USB port, the charge control unit connects the first output end and the second output end to a differential positive end and a differential negative end of the USB port, respectively, to enter a rapid charging mode.

12. The control circuit according to claim 11, wherein the first output end and the second output end are connected to a first setting voltage and a second setting voltage, respectively.

13. The control circuit according to claim 11, wherein the first output end and the second output end are short-circuited.

14. The control circuit according to claim 11, wherein the control circuit further includes a second circuit unit coupled to the charge control unit and including a third output end and a fourth output end, and when the first output end and the second output end are connected to the differential positive end and the differential negative end, respectively, and the external apparatus does not give a response to the charge control unit, the differential positive end and the differential negative end are switched to couple to the third output end and the fourth output end, respectively.

15. The control circuit according to claim 14, wherein the third output end and the fourth output end are short-circuited.
